(19) United States
(12) Patent Application Publication
(10) Pub. No.: US 2024/0254416 A1
(43) Pub. Date: Aug. 1, 2024

(54) A TABLET COMPOSITION

(71) Applicant: CONOPCO, INC., D/B/A UNILEVER, Englewood Cliffs, NJ (US)

(72) Inventors: Girish Muralidharan, Banashankari (IN); Rajeesh Kumar Ramachandran, Hosur (IN)

(21) Appl. No.: 18/560,843

(22) PCT Filed: May 30, 2022
(86) PCT No.: PCT/EP2022/064554

§ 371 Date: Nov. 14, 2023

(30) Foreign Application Priority Data
Jun. 7, 2021 (EP) 21177956.6

(51) Int. Cl. C11D 17/00; C11D 1/22; C11D 1/83; C11D 3/00; C11D 3/20; C11D 3/22

(52) U.S. Cl. CPC C11D 17/0091; C11D 1/22; C11D 1/8305; C11D 3/0005; C11D 3/2082; C11D 3/221; C11D 2111/14

(57) ABSTRACT

The present invention relates to a detergent tablet, in particular, it relates to a detergent tablet for providing a liquid cleaning composition on dissolution in water. It discloses a unit dose tablet comprising at least 10% by weight surfactant; and a dissolving aid selected from hydrated monosaccharides, hydrated disaccharides, hydrated oligosaccharides and combinations thereof, wherein the ratio of the surfactant to the dissolving aid is at least 1:1.5 by weight. It further discloses a process for forming a liquid cleaning composition comprising the steps of providing water in a container, adding said tablet into the water, wherein the ratio of tablet to water is in the range from 1:5 to 1:100 by weight.

### FIELD OF THE INVENTION

The present invention relates to a detergent tablet. In particular, it relates to a detergent tablet for providing a liquid cleaning composition on dissolution in water.

### BACKGROUND OF THE INVENTION

Consumers spend considerable amount of time and effort in cleaning their households. They prefer to use different cleaning compositions depending on the substrates to be cleaned.

Typically, such compositions differ in terms of their ingredients such as, detersive agents, builders, perfume, soil release polymers etc. Moreover, a particular composition is available in different formats such as, powder, liquid, tablet, pod etc.

Typically, a composition in tablet format contains concentrated detergent. Consumers dissolves the tablet in water to form a liquid cleaning composition and use it. Tablets are compact in size. Hence requires less packaging material compared to a liquid or powder detergent having similar level of detersive agent. Often the packaging materials includes polyethylene, polyethylene terephthalate etc. which are predominantly sourced from non-renewable resources. There are continuous efforts to reduce such consumptions, and tablet format perfectly fits in to this. Moreover, when a tablet is formulated as a unit dose, it provides relief to consumer from adjudging and dosing right amount of composition in water. Hence tablet format is gaining popularity in this space.

In present context, a tablet contains a unit dose of concentrated detergent, which forms a liquid cleaning composition on dissolution in water. For such tablets, it is desirable that the tablets should be hard enough to resist breakage in transportation/storage and at same time it should dissolve fast in contact with water. A tablet is formed by compacting a homogenised powder comprising the required ingredients. In one hand, a high compression force leads to hard tablets which fails to dissolve fast. On the other hand, lower compression force leads to loosely packed ingredients which helps in faster dissolution, however, does not have the required strength. It is desirable to have a fast-dissolving tablet with sufficient strength.

One way to improve the performance of tablets is to incorporate a disintegrant in the composition which disintegrates the tablet in water, helping in faster dissolution. However, most of the disintegrants are insoluble in water leaving residue upon dissolution in the liquid composition, which is not preferred by consumers.

In this context, US 2005/0148488 (Henkel, 2005) describes a multiphase detergent tablet that has at least one active phase containing one or more washing or cleaning substances, a solid matrix enclosing the substances in the form of a solidified melt, where the matrix material is selected from sugars, sugar acids, sugar alcohols, and any mixtures thereof. The solid matrix has a solubility above 100 gm/L at 20° C. and it is at least 10% of the total weight of the active phase.

WO 00/27986 (Henkel, 2000) describes detergent tablets, which are characterized by high hardness coupled with short disintegration times. Such tablets can be produced by addition of fine-particle sugar with at least 50% by weight of the sugar particles having size smaller than 400 microns.

US 2012/0190607 (Ecolab USA, 2012) describes solid detergent compositions containing at least one alkali metal silicate, at least one poly-carboxylic acid, at least one saccharide or sugar alcohol and water. Suitable saccharides include sucrose, fructose, inulin, maltose and lactulose. And may be present in the composition in a concentration of at least 0.5% by weight.

However, there is a need for an improved detergent tablet which forms a cleaning composition which provides faster dissolution in water without leaving any residue.

### OBJECT OF THE INVENTION

In view of the foregoing, it is an object of the present invention to provide a composition in a tablet format.

It is another object of the present invention to provide a detergent tablet.

It is yet another object of the present invention is to a provide a unit dose tablet which forms a liquid cleaning composition on dissolution in water.

It is yet another object of the present invention to provide a unit dose tablet which is hard to resist breakage during storage and transportation yet dissolve fast in water to form a liquid cleaning composition.

It is yet another object of the present invention to provide a unit dose tablet composition which forms a transparent liquid cleaning composition on dissolution in water.

The present inventors while working on this have surprisingly found that a detergent tablet comprising an effervescent system and a dissolving aid selected from hydrated monosaccharides, hydrated disaccharides, hydrated oligosaccharides, dissolves fast in water providing a transparent liquid cleaning composition.

Thus, satisfying one or more of the above-mentioned objects.

### SUMMARY OF THE INVENTION

In a first aspect, the present invention provides a unit dose tablet comprising at least 10% by weight surfactant; and a dissolving aid selected from hydrated monosaccharides, hydrated disaccharides, hydrated oligosaccharides and combinations thereof, wherein the ratio of the surfactant to the dissolving aid is at least 1:1.5 by weight.

In a second aspect, the present invention provides a process for forming a liquid cleaning composition comprising the steps of providing water in a container, adding a tablet according to the first aspect into the water, wherein the ratio of tablet to water is in the range from 1:5 to 1:100 by weight.

In another aspect, the present invention provides the use of a unit dose tablet according to the first aspect for dishwashing.

These and other aspects, features and advantages will become apparent to those of ordinary skill in the art from reading of the following detailed description. For the avoidance of doubt, any feature of one aspect of the present invention may be utilized in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

By “unit dose” as used herein, implies an amount of a composition suitable for single time use. By “dissolving aid” as used herein refers to compounds added as excipient in a tablet, which dissolve in contact with water, thus helping in disintegration of the tablets thereby provides faster dissolution.

According to the present invention there is provided a unit dose tablet comprising at least 10% by weight surfactant, and a dissolving aid selected from hydrated monosaccharides, hydrated disaccharides, hydrated oligosaccharides and combinations thereof, wherein the ratio of the surfactant to the dissolving aid is at least 1:1.5 by weight.

The tablet according to the present invention comprises a surfactant for providing detersive benefit. The tablet comprises at least 10% by weight of surfactant. Lowering the amount of surfactant further may affect the cleaning performance.

Preferably the amount of the surfactant is in the range 10 to 40% by weight of the tablet.

Preferably higher the amount of surfactant is better the performance of the tablet. More preferably the amount of surfactant is in the range 10 to 35% by weight, and most preferably 10 to 30% by weight of the tablet.

Preferably the surfactant in the tablet is selected from anionic, non-ionic, surfactant and combinations thereof.

### Surfactant

Preferably the surfactant is an anionic surfactant. Anionic surfactant suitable for the present invention includes salts of organic sulphates and sulphonates having alkyl radicals containing from about 8 to about 22 carbon atoms, the term “alkyl” being used to include the alkyl portion of higher acyl radicals. Examples of such materials include alkyl sulphates, alkyl ether sulphates, alkaryl sulfonates, alpha-olefin sulfonates and mixtures thereof. The alkyl radicals preferably contain from 10 to 18 carbon atoms and may be unsaturated. The alkyl ether sulphates may contain from one to ten ethylene oxide or propylene oxide units per molecule, and preferably contain one to three ethylene oxide units per molecule.

The suitable anionic surfactant includes alkylbenzene sulfonates. Preferably in an embodiment suitable for dishwash comprises linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulpho-phenyl isomers except for the 1-phenyl isomer. LAS is normally formulated into compositions in acid (i.e. HLAS) form and then at least partially neutralized in-situ. The counterion for anionic surfactants is generally an alkali metal such as sodium or potassium; or an ammoniacal counterion such as monoethanolamine, (MEA) diethanolamine (DEA) or triethanolamine (TEA), monoisopropanolamine (MIPA). Mixtures of such counterions may also be employed. Sodium and potassium are preferred.

Preferably the suitable anionic surfactant includes alkyl sulphate surfactant (PAS), such as non-ethoxylated primary and secondary alkyl sulphates with an alkyl chain length of from 10 to 18.

Preferably the tablet suitable for laundry application may contain alkyl ether sulphates having a straight or branched chain alkyl group having 10 to 18, more preferably 12 to 14 carbon atoms and containing an average of 1 to 3 ethylene oxide (EO) units per molecule. A preferred example is sodium lauryl ether sulphate (SLES) in which the predominantly C12 lauryl alkyl group has been ethoxylated with an average of 3EO units per molecule. The alkyl ether sulphates may be used alone or in combination with any other anionic surfactant.

Preferably the anionic surfactant is selected from primary alkyl sulphate, alkyl benzene sulphonates, alkyl ether sulphates and mixture thereof.

Preferably the amount of the anionic surfactant is in the range up to 100% by weight of the total amount of the surfactant. More preferably, the amount of anionic surfactant is in the range 10 to 90%, even more preferably 20 to 80%, most preferably 30 to 70% by weight of the total amount of surfactant.

The tablet according to the present invention preferably comprises a non-ionic surfactant in addition to anionic surfactant.

Suitable non-ionic surfactants include water soluble aliphatic ethoxylated non-ionic surfactants including the primary aliphatic alcohol ethoxylates and secondary aliphatic alcohol ethoxylates. This includes the condensation products of a higher alcohol (e.g., an alkanol containing about 8 to 16 carbon atoms in a straight or branched chain configuration) condensed with about 4 to 20 moles of ethylene oxide, for example, lauryl or myristyl alcohol condensed with about 10 moles of ethylene oxide (EO), tridecanol condensed with about 6 to 15 moles of EO, myristyl alcohol condensed with about 10 moles of EO per mole of myristyl alcohol, the condensation product of EO with a cut of coconut fatty alcohol containing a mixture of fatty alcohols with alkyl chains varying from 10 to about 14 carbon atoms in length and wherein the condensate contains either about 6 moles of EO per mole of total alcohol or about 9 moles of EO per mole of alcohol and tallow alcohol ethoxylates containing 6 EO to 11 EO per mole of alcohol.

Examples of the foregoing non-ionic surfactants include, but are not limited to, the Neodol (trade mark, ex Shell), which are higher aliphatic, primary alcohol containing about 9 to 15 carbon atoms, such as C9 to C11 alkanol condensed with 4 to 10 moles of ethylene oxide (Neodol 91-8 or Neodol 91-5), C12 to C13 alkanol condensed with 6.5 moles ethylene oxide (Neodol 23-6.5), C12 to C15 alkanol condensed with 12 moles ethylene oxide (Neodol 25-12), C14 to C15 alkanol condensed with 13 moles ethylene oxide (Neodol 45-13), and the like. Such ethoxamers have an HLB (hydrophobic lipophilic balance) value of about 8 to 15 and give good O/W emulsification, whereas ethoxamers with HLB values below 7 contain less than 4 ethylene oxide groups and tend to be poor emulsifiers and poor detergents.

Another group of suitable non-ionic surfactants are alkyl polyglycosides(APG) which are sugar derivatives of fatty alcohol. Example of such surfactants are decyl glucoside, lauryl glucoside, myristyl glucoside.

The tablet according to the present invention may further comprises a cationic and amphoteric surfactant.

Suitable cationic surfactants are quaternary ammonium salts. According to the present invention quaternary ammonium salts are characterised in that the ammonium salt has the general formula: R1R2R3R4N+X—wherein R1 is a C12 to C18 alkyl group, each of R2, R3 and R4 independently is a C1 to C3 alkyl group and X is an inorganic anion. R1 is preferably a C14 to C16 straight chain alkyl group, more preferably C16. R2, R3 and R4 are preferably methyl groups. The inorganic anion (X—) is preferably chosen from halide, sulphate, bisulphate or hydroxide.

For the purposes of this invention, a quaternary ammonium hydroxide is considered to be a quaternary ammonium salt. More preferably the anion is a halide ion or sulphate, most preferably a chloride or sulphate. Cetyl-trimethylammonium chloride is a specific example of a suitable compound and commercially abundantly available.

Another type of quaternary ammonium cationic surfactant is the class of benzalkonium halides, also known as alkyldimethylbenzylammonium halides. The most common type being benzalkonium chloride, also known as alkyldimethylbenzylammonium chloride (or ADBAC).

Suitable amphoteric surfactants include derivatives of aliphatic quaternary ammonium, sulphonium and phosphonium compounds having an aliphatic radical of from 8 to 18 carbon atoms and an aliphatic radical substituted by an anionic water-solubilising group, for instance 3-(N—N-dimethyl-N-hexadecylammonium) propane-1-sulphonate betaine, 3-(dodecylmethyl sulphonium) propane-1-sulphonate betaine and 3-(cetylmethylphosphonium) ethane sulphonate betaine.

Examples of amphoteric surfactants suitable for the present invention include cocoamidopropyl betaine (CAPB), cocoamidopropyl amine oxide (CAPAO), cocodiethanol amide (CDEA) and cocomonoethanol amide (CMEA).

### Dissolving Aid

The tablet comprises a dissolving aid. In tablet context, dissolving aid refers to compounds preferably present as excipient, helps in dissolution of the tablet in water. Without wishing to be limited by theory it is believed that dissolving aids dissolves quickly in contact with the water, thus disintegrating the tablet into pieces. This accelerates dissolution of other active ingredients present in the tablet such as, detersive actives, into the water. Typically dissolving aids are salts having high water solubility and different from conventional disintegrants used in tablets.

Conventional disintegrants used in tablet making, are typically insoluble salts. A tablet containing such disintegrants, when added to water, it leaves residues in the water. Thus, it could not provide a transparent liquid cleaning composition.

In present context, the dissolving aid in combination with the surfactant in specific ratio acts synergistically and dissolve the tablet quickly.

The dissolving aid is selected from hydrated monosaccharides, hydrated disaccharides, hydrated oligosaccharides and mixture thereof. The ratio of the surfactant to the dissolving aid is at least 1:1.5 by weight. Preferably the ratio of the surfactant to the dissolving aid is at least 1:2, more preferably 1:3 by weight. Preferably the ratio of the surfactant to the dissolving aid is at most 1:8, more preferably 1:7, even more preferably 1:6 and most preferably 1:5 by weight.

Preferably the hydrated monosaccharide, hydrated disaccharide and hydrated oligosaccharides with high solubility are suitable for the invention. Preferably the water solubility of the hydrated monosaccharides, hydrated disaccharides, hydrated oligosaccharides is at least 100 gm/L, more preferably at least 200 gm/L, even more preferably at least 300 gm/L and most preferably at least 400 gm/L at 25º C.

Most preferred dissolving aid is Glucose Monohydrate.

Preferably the amount of the dissolving aid is in the range from 15 to 90% by weight, more preferably, 20 to 80% by weight, and most preferably 25 to 70% by weight of the tablet.

### Organic Acid

The tablet according to the present invention may comprises an organic acid.

Preferably the organic acid is selected from citric acid, tartaric acid, fumaric acid, malic acid, adipic acid, succinic acid, and combinations thereof. Preferably the organic acid is citric acid.

Preferably the tablet comprises 1 to 50% by weight, more preferably 3 to 45% by weight and most preferably 5 to 40% by weight of organic acid.

### Water-Soluble Inorganic Salt

The tablet may comprise a water-soluble inorganic salt. Suitable inorganic salts include alkali metal salt of carbonate or bicarbonate or silicates and combinations thereof.

Preferably the carbonate or bicarbonate salt is selected from sodium carbonate, potassium carbonate, calcium carbonate, sodium bicarbonate, potassium bicarbonate, calcium carbonate, calcium bicarbonate and magnesium carbonate as well as mixtures thereof.

Preferably the tablet comprises 1 to 50% by weight, more preferably 3 to 45% by weight and most preferably 5 to 40% by weight of water-soluble inorganic salt.

Preferably the ratio of the bicarbonate/carbonate salt to the organic acid is in the range 10:1 to 1:10, more preferably 5:1 to 1:5, most preferably 3:1 to 1:3 by weight. Most preferably, the ratio of the bicarbonate salt to the organic acid or salt of organic acid or salt of inorganic acid is 1:1.

### Application

Preferably in one embodiment, the tablet according to the present invention is formulated for laundering. The term “laundering” herein refers to treating or washing fabrics. The tablet may be used directly for laundering, wherein a consumer drops the tablet in a bucket of water forming a wash liquor and soak their laundry load in the wash liquor and subsequently wash it. In such applications, it is desired that the amount of surfactant should be sufficient to clean the fabrics, however, should not leave excess detersive, which may force the consumer to rinse the fabric multiple time. Therefore, in such embodiments, preferably the amount of surfactant is in the range 10 to 40% by weight, more preferably 10 to 30%, most preferably 10 to 20% by weight of the tablet.

Preferably, in laundry context, the anionic surfactant in the tablet is selected from alkyl benzene sulphonates, alkyl ether sulphates and mixture thereof.

In aforesaid cases, the tablet according to the present invention may further comprises other ingredients such as, builders, sequestrants, soil release polymers, perfume, enzyme, fluorescer. Preservative etc.

In another embodiment, the tablet according to the present invention may be used for hard surface cleaning. Hard surface cleaning compositions are generally used for cleaning surfaces such as, kitchen utensils, dishes, kitchen platform, tabletop etc. One of such embodiments is a tablet for dishwashing.

In dishwashing context, preferably the anionic surfactant in the tablet is selected from primary alkyl sulphate, alkyl benzene sulphonates and mixture thereof.

In another embodiment, the tablet may be used for machine dishwashing, where a consumer dose the tablet in dishwashing machine. Moreover, it is preferable not to have excessive foam. Therefore, tablet according to such embodiment may contain an antifoaming agent.

Preferably tablets according to the present invention suitable for dishwashing further comprises a solvent for providing degreasing benefit.

The tablet according to the present invention may be provided with a container. The tablet may be dosed in the container containing sufficient water. The tablet dissolves in the water thereby providing a cleaning composition. The container may be equipped with a spray head or foam engine, which helps in dispensing the cleaning composition directly on the surface as spray or foam.

It is also possible to provide a cleaning product comprising a tablet as claimed herein along with a foam dispenser. The tablet dissolves in water providing a liquid cleaning composition, which thereupon may be filled in the dispenser. Alternatively, the tablet may be dosed in the dispenser and water is added, which forms a liquid cleaning composition inside the dispenser. The foam dispenser herein may be a pressurised gas-based or foam trigger-based dispenser.

Preferably the foam dispenser comprises a container to hold the composition and a foam trigger, which includes a trigger lever, a pump, a mixing chamber and a nozzle. The pump comprises a piston moving in a cavity against a spring. The cavity is in fluid communication with the container and the mixing chamber, wherein it has one-way valves which allow the composition to flow from the container to the mixing chamber. Typically, the foam trigger is actuated by pressing the trigger lever, which in turn pressed the piston against the spring thereby pushing the composition stored in the cavity to the mixing chamber. In the mixing chamber the composition mixed with air and pass through a mesh before dispensing out of the nozzle as foam. On subsequent release of the trigger lever, the spring push back the piston, thereby the empty cavity fills with the composition flowing from the container. Foam dispensers equipped with foam trigger rely on the pump action, hence do not require a pressurised gas.

It may also possible that the foam dispenser comprises a pressurised gas, stored along with the composition in the container. Such dispenser is activated by opening a one-way valve, thereby releases the gas along with composition through a nozzle and dispenses a foam.

### Water-Soluble Packaging

Preferably the tablet according to the invention is single dose format. Typically, the consumer drops the tablet directly in to the water to form a liquid detergent. Preferably the tablet is packed in a water-soluble primary packaging, which dissolve in contact with water releasing the tablet into the water.

### Process of Making Tablet

Preferably, tablets are prepared following conventional tablet making process. In the process a homogenised dry powder is prepared by mixing the ingredients in specified ratio. Subsequently, the powder is filled in a die-block and compressed to form the tablet. A rotary press or a hydraulic press maybe employed to compress the powder to tablet.

Preferably the pressure applied during the compression is in the range 1 to 100 kg-f/cm2, more preferably 2.5 to 75 kg-f/cm2, even more preferably 5 to 50 kg-f/cm2, and most preferably 7.5 to 30 kg-f/cm2.

There is provided a method for forming a liquid detergent comprising the steps of providing water in a container, adding a tablet according to the present invention, wherein the ratio of the tablet to water is in the range of 1:5 to 1:100 by weight. More preferably the ratio of the tablet to water is in the range 1:10 to 1:70 by weight, most preferably 1:15 to 1:50 by weight.

There is provided a use of a tablet according to according to present invention for dishwashing. Preferably the tablet is dissolved in a bowl of water to form a liquid dishwashing detergent and subsequently used by consumers for hand dishwashing.

### EXAMPLES

### Tablets

Dry mix compositions were prepared according to the recipes provided in table 1. In subsequent step, each dry mix composition was taken in die-block and compressed by applying a pressure of 10 kg-f/cm2, thereby forming the tablet. Each tablet weighs between 7 to 12 gm.

### Evaluation of the Tablets

For evaluating the performance of the tablets made by said process, each tablet was added in 250 ml water and allowed to dissolve. The disintegration time of each tablet was noted using a stopwatch.

TABLE 1

| | Com- | Com- | Com- | Com- |
|---|---|---|---|---|
| Material | position | position | position | position |
| (% w/w) | 1 | 2 | 3 | A |
| Na-Linear alkyl | 15.3 | 20.5 | 23.1 | 26.5 |
| benzene sulphonate | | | | |
| Glucose | 64.4 | 52.3 | 46.2 | 38.2 |
| Monohydrate | | | | |
| Citric Acid | 20.3 | 27.3 | 30.8 | 35.3 |
| Ratio of surfactant | 1:4.2 | 1:2.6 | 1:2 | 1:1.4 |
| to glucose | | | | |
| monohydrate → | | | | |
| Disintegration time | 2 | 3 | 6 | More than |
| (minutes)→ | | | | 10 minutes |

Composition 1 to 3 are according to the invention and composition A is comparative.

1. A unit dose tablet comprising:
a) at least 10% by weight surfactant; and,
b) a dissolving aid selected from hydrated monosaccharides, hydrated disaccharides, hydrated oligosaccharides and combinations thereof; and
c) an organic acid,
wherein the ratio of the surfactant to the dissolving aid is in the range 1:1.5 to 1:8 by weight,
wherein the solubility of the hydrated monosaccharide, hydrated disaccharide, hydrated oligosaccharide in water is at least 300 gm/L at 25° C.

2. A unit dose tablet according to claim 1, wherein the amount of the surfactant is in the range from 10 to 40% by weight of the tablet.

3. A unit dose tablet according to claim 1, wherein the surfactant is selected from anionic surfactant, non-ionic surfactant and combinations thereof.

4. A unit dose tablet according to claim 3, wherein the anionic surfactant is selected from primary alkyl sulphate, alkyl benzene sulphonates, alkyl ether sulphates and combinations thereof.

5. A unit dose tablet according to claim 3, wherein the non-ionic surfactant is selected from alcohol ethoxylate, alkyl polyglycoside and combinations thereof.

6. A unit dose tablet according to claim 1, wherein the amount of the dissolving aid is in the range 15 to 90% by weight of the tablet.

7. A unit dose tablet according to claim 1, wherein the solubility of the hydrated monosaccharide, hydrated disaccharide, hydrated oligosaccharide in water is at least 400 gm/L at 25° C.

8. A unit dose tablet according to claim 1, wherein the dissolving aid is glucose monohydrate.

9. A unit dose tablet according to claim 1, further comprising 1 to 50% by weight of the organic acid.

10. A unit dose tablet according to claim 9, wherein the organic acid is selected from citric acid, tartaric acid, malic acid, adipic acid and combinations thereof.

11. A unit dose tablet according to claim 1, further comprising 1 to 50% by weight water soluble inorganic salt.

12. A unit dose tablet according to claim 11, wherein the inorganic salt is selected from alkali metal salt of carbonate or bicarbonate or silicates and combinations thereof.

13. A process for forming a liquid cleaning composition comprising the steps of:
a) providing water in a container; and
b) adding a tablet according to claim 1 into the water,
wherein the ratio of the tablet to water is in the range from 1:5 to 1:100 by weight.

14. Use of a tablet according to claim 1 for dishwashing.
